(19) United States
(12) Patent Application Publication
(10) Pub. No.: US 2014/0100723 A1
(43) Pub. Date: Apr. 10, 2014

(54) AUTOMATED GUIDED VEHICLE SIDESTEP MOTION APPARATUS AND METHOD

(71) Applicant: Toyota Motor Engineering & Manufacturing North America, Inc., (US)

(72) Inventors: Colin Martin O'Halloran, Kitchener (CA); Trevor Lloyd Machan, Baden (CA); Yogesh Brahmbhatt, Brampton (CA); Jonathan Philip Kenneth Eng, Waterloo (CA)

(73) Assignee: Toyota Motor Engineering & Manufacturing North America, Inc., Erlanger, KY (US)

(21) Appl. No.: 13/644,992

(22) Filed: Oct. 4, 2012

(51) Int. Cl. G05D 1/02

(52) U.S. Cl. 701/19

(57) ABSTRACT

A method and apparatus for controlling the path of movement of an automatic guided vehicle relative to a first guidepath laterally along first and second cross tracks to a second guidepath laterally offset from the first guidepath. The turn indicator is mounted relative to the first and second guide tracks. A turn indicator sensor carried on the automatic guided vehicle detects the turn indicator. A controller responsive to the sensor output positions the automatic guided vehicle for movement of the first drive wheel along one of the cross tracks and the second guide wheel along the other cross track laterally from the first guidepath to the second guidepath.

### BACKGROUND

The present description relates, in general, to automated guided vehicles (AGV).

Unmanned, automatic guided vehicles or AGVs are used in factories, warehouses, and other applications to carry loads along a predetermined path on the facility floor typically between a load pick-up station and a load drop-off or unload station.

An AGV includes a base or chassis having one or more driving wheels, at least one of which has a steering mechanism. A controller is mounted on the chassis for controlling the forward and/or rearward directional movement of the drive wheels as well as to control the steering mechanism to allow the AGV to execute a right or left hand turn. Article carrying structure, particular to the load to be carried by the AGV, is mounted on the chassis.

A guidepath is laid out on the facility floor which typically defines a closed loop path defined by a magnetic or optically reflective tape strip which includes straight, curved and angular turn segments.

A magnetic sensor mounted on the AGV chassis senses the magnetic tape and provides signals to the controller which in turn controls the drive wheel steering mechanism to maintain the drive wheels on the magnetic tape so that the AGV moves along the guidepath.

However, AGVs having a large chassis or AGVs which carry elongated articles or parts or, simply, AGVs used in tight confined areas require excessive clearance to turn. The need for a large turn area has prevented the application of AGVs in many areas of a manufacturing plant, warehouse, or other facility; or has required a redesign of the AGV close loop path and a relocation of the manufacturing or storage facility tools or machines to provide the turning clearance for such AGVs.

It would be desirable to provide a method and apparatus for an AGV which addresses this problem by allowing movement of an AGV in a small tight defined area.

### SUMMARY

An apparatus for controlling the path of movement of an automated guide vehicle along a guidepath including a first guidepath and a second guidepath laterally offset from the first guidepath. A first cross track is disposed between the first and second guidepaths. A second cross track spaced from the first cross track, is interconnected between the first and second guidepath. An automated guide vehicle movable in at least a first direction along the guidepath includes a first independently steerable drive wheel, a second independently steerable drive wheel, a first sensor associated with the first drive wheel for sensing the guidepath relative to the first drive wheel, a second sensor associated with the second drive wheel for sensing the guidepath relative to the second drive wheel, and a controller. In response to the position of the automatic guided vehicle relative to the first and second guide tracks, the controller controls the position of the automatic guided vehicle to allow the first drive wheel to follow one of the first and second cross tracks and the second drive wheel to follow the other cross track to move the automatic guided vehicle laterally in a sideways manner between the first and second guidepaths.

A turn indicator is fixedly positioned relative to the first and second cross tracks. A turn indicator sensor is carried by the automatic guided vehicle for detecting the turn indicator. The controller, using an output from the turn indicator sensor, determines the position of the automatic guided vehicle relative to the first and second cross tracks to control the movement of the automatic guided vehicle along the first and second cross tracks.

Optionally a third sensor is mounted rearwardly of the first drive wheel to sense the guidepath when the automatic guided vehicle is moving in a second direction opposite from the first direction. A fourth sensor is mounted rearwardly of the second drive wheel to sense the guidepath when the automatic guided vehicle is moving in a second direction opposite from the first direction.

A bi-directional drive motor is coupled to each of the first and second drive wheel.

In one aspect, the second guidepath is disposed to the right side of the first guidepath with respect to the direction of travel of the automatic guided vehicle in the first direction. The second guidepath can also or alternately be disposed to the left side of the first guidepath with respect to the direction of the travel of the automatic guided vehicle.

The first and second cross tracks are disposed at an angle of about 45° between the first and second guidepaths.

The turn indicator is fixedly located relative to the first and second cross tracks in a position such that the turn indicator sensor detects the presence of the turn indicator when the first drive wheel of the automatic guided vehicle has passed the first one of the cross tracks when the vehicle is moving in the first direction.

A method of controlling the movement of an automatic guided vehicle along a guidepath including at least a first guidepath, first and second independently steerable drive wheels, comprises:

providing a second guidepath laterally offset from the first guidepath,

interconnecting first and second spaced across tracks between the first and second guidepaths,

mounting a turn indicator in a position relative to the first and second cross tracks to indicate a sideways turn movement of the automatic guided vehicle from the first guidepath to the second guidepath,

providing a turn indicator sensor on the automatic guided vehicle for detecting the turn indicator, and

executing a stored program by a controller to control the movement of the automatic guided vehicle along the first guidepath and,

in response to a signal from the turn indicator sensor, controlling the position of the automatic guided vehicle to allow the first drive wheel to follow one cross track and the second drive wheel to follow the other cross track to move the automatic guided vehicle laterally between the first and second guidepaths.

The method includes mounting the turn indicator relative to the first and second cross tracks in a position so that the first drive wheel passes one of the first cross tracks before the turn indicator sensor detects the presence of the turn indicator.

The method further includes disposing the second guidepath laterally to the right side of the guidepath and/or the left side with respect to the first direction of travel of the automatic guided vehicle.

The method disposes the first and second cross tracks at an angle, about 45° angle, with respect to the first and second guidepaths.

### BRIEF DESCRIPTION OF THE DRAWING

The various features, advantages and other uses of the AGV motion control apparatus and method will become more apparent by referring to the following detailed description and drawing in which:

FIG. 1 is a schematic representation of a prior art AGV turn clearance space requirement;

FIG. 2 is a schematic representation of the turn space requirement for an AGV using the present method and apparatus;

FIG. 3A is a bottom elevational view of an example of an AGV which can use the present sideways movement method and apparatus;

FIG. 3B is a partial bottom perspective view of the AGV shown in FIG. 3A.

FIG. 4 is a pictorial representation of closed loop AGV guidepath;

FIG. 5 is an enlarged, partial plan view of a portion of magnetic track of the guidepath showing left edge and right edge steering modes of the AGV movement along a guidepath;

FIGS. 6, 7, 8 and 9 are pictorial representations of an AGV executing a right hand side step motion movement according to the present method and apparatus;

FIGS. 10 and 11 are pictorial representations of an AGV executing a left hand side step motion according to the present method and apparatus; and

FIG. 12 is a flow chart depicting the turn sequence control steps for an AGV executing a side step motion.

### DETAILED DESCRIPTION

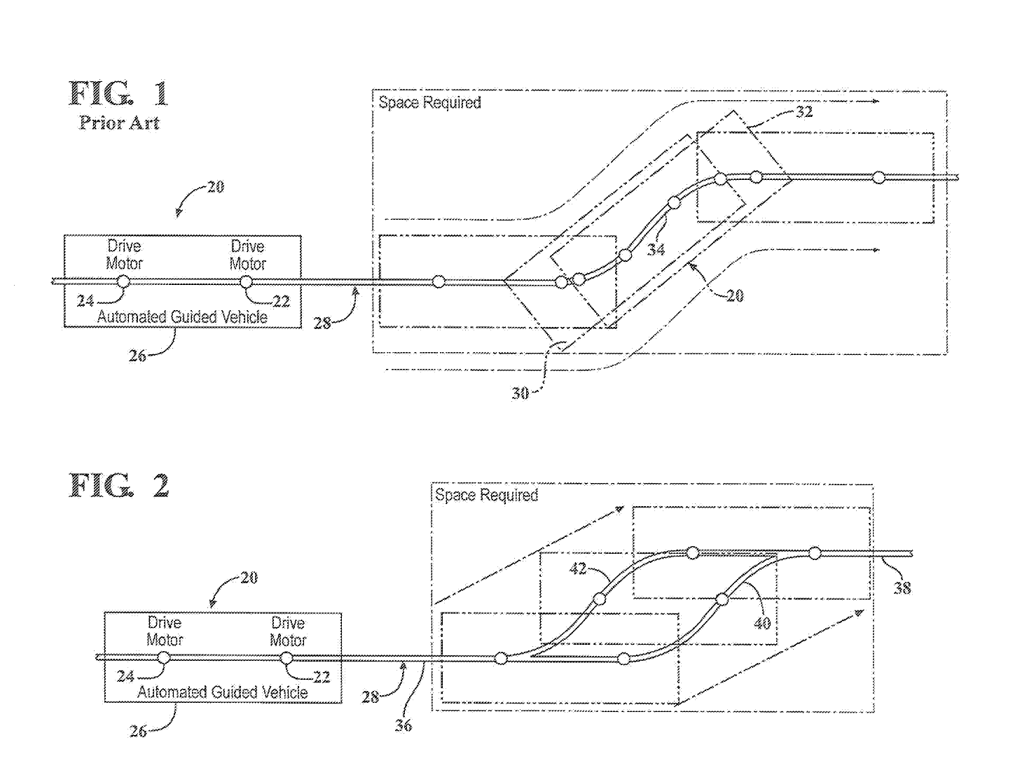

In FIG. 1, there is depicted a pictorial representation an AGV 20 which has a first drive wheel 22 and a second drive wheel 24 (taken in a typical direction of forward and reverse movement of the AGV 20), mounted on a chassis or frame 26. The AGV 20 follows a guidepath 28 formed of a magnetic or optical tape.

Due the large length of the AGV 20, when the AGV 20 executes a turn, such as the left hand turn shown by example in FIG. 1, successive rear and front corners 30 and 32 of the AGV 20 will project a considerable distance outward beyond the outline of the AGV 20 as the AGV 20 moves along the linear portions of the guidepath 28. These large over hang areas 30 and 32 consume additional plant floor space which may cause a rearrangement of the plant facilities, such as shelves, part bins, tools, machines, or the inability to use the AGV 20 in such a tight defined location.

FIG. 2 depicts a pictorial representation of the AGV 20 which utilizes a novel side step motion to enable the AGV 20 to execute a turn, such as the left hand turn illustrated in FIG. 2, between the first portion 36 of the guidepath 28 and a second, generally parallel portion 38 of the guidepath 28.

The side step motion according to the present method and apparatus utilizes two generally identically shaped, generally parallel disposed first cross track segment 40 and second cross track segment 42. In general, and as will be described in greater detail hereafter, the AGV 20 moves along the first linear segment 36 of the guidepath 28 until the first drive wheel 22 passes the cross track segment 42. At this time, the controller on the AGV 20 executes a left turn sequence for the longitudinally spaced, co-axial first drive wheel 22 and second drive wheel 24. This causes the first drive wheel 22 to move along the first cross track segment 40 and the second wheel 24 to move along the second cross track segment 42, generally in parallel with each other. This sidestep or crab movement translates the AGV 20 in a general parallel orientation between the first and second linear segments 36 and 38 and eliminates the overhang areas 30 and 32 in the prior art turn sequence shown in FIG. 1.

In the following description, movement of the AGV 20 from left to right in the various orientations of the guidepath 28 will be described as a direction movement or a forward direction. An opposite movement or motion of the AGV 20 from right to left along the guidepath 28 will be termed a reverse or rearward direction of movement or simply direction B.

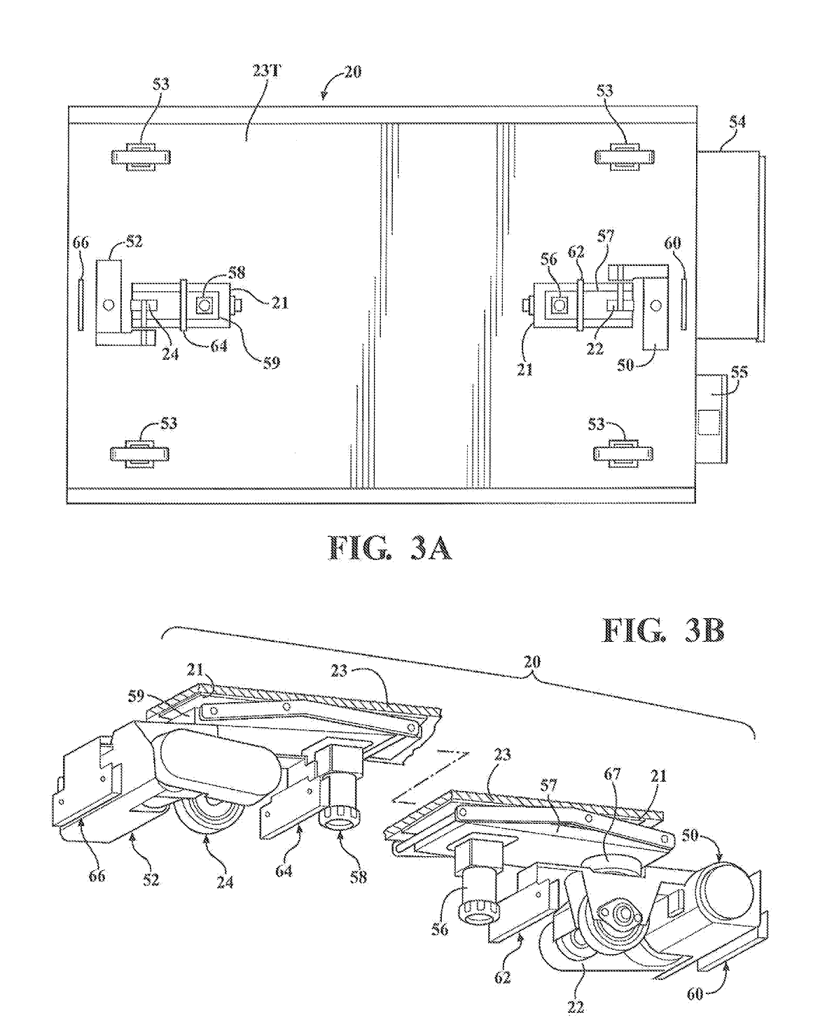

Referring now to FIGS. 3A and 3B, there is depicted in more detailed schematic illustration of the AGV 20. For example, the AGV 20 depicted in FIGS. 3A and 3B can be a Creform FH-B35090 bidirectional AGV. A large base 23 having generally rectangular shape is mounted on the AGV 20. The base 23 is fixed to a pair of mounting plates 21 by bolts on other fasteners. The mounting plates 21 formed by splitting the original elongated mounting plate of the AGV 20 into two separate plates 21 each fixed to one of two plates 57 and 59 each carrying one of the drive assemblies of the AGV 20, such as a first drive assembly coupled to the plate 57 and a second drive assembly coupled to the plate 59. A steering mechanism is provided for each drive assembly and includes a rotatable, electric motor driven, steering mechanism 56 and 58, respectively. Activation of the steering mechanisms 56 and 58 via control signals from a controller, described hereafter, causes the electric motor of each steering mechanism 56 and 58 to rotate. The output of each steering mechanism motor is coupled through a sprocket to a drive belt which is in turn coupled to a sprocket or gear fixedly rotating with a bearing 67 for the plate 57 shown in FIG. 3B. The bearing rotatably supports the first drive assembly which includes the first drive wheel 22, the drive motor 50 and sensors 60 and 62. The second drive assembly also includes a similar second drive wheel 24, another drive motor 52 and sensors 64 and 66. Activation of either of the drive motors of the steering mechanisms 56 and 58 causes the respective first or second drive assemblies to pivot about a vertical axis extending through the bearing 67 relative to the plates 57 or 59 in the appropriate direction to move the first and second independent drive wheels 22 and 24 of the AGV 20 along the guidepath 28 in a linear straight path of movement or in a turn or arcuate motion to follow a curved portion of the guidepath 28.

Consistent with the above-defined forward and rearward direction of movement of the AGV 20, the plate 57 supports the first drive wheel 22 located at one edge of the chassis 21 and the plate 59 supports second located drive wheel 24 located adjacent an opposite edge of the chassis 21. Each of the first and second drive wheels 22 and 24 is coupled to one electric drive motor 50 and 52, respectively. The drive motors 50 and 52 are independently driven by a controller 55 also mounted on the base 23. Each drive motor 50 and 52 is capable of opposite direction of output shaft rotation to enable the AGV 20 to move in either forward or rearward directions along the guidepath 28.

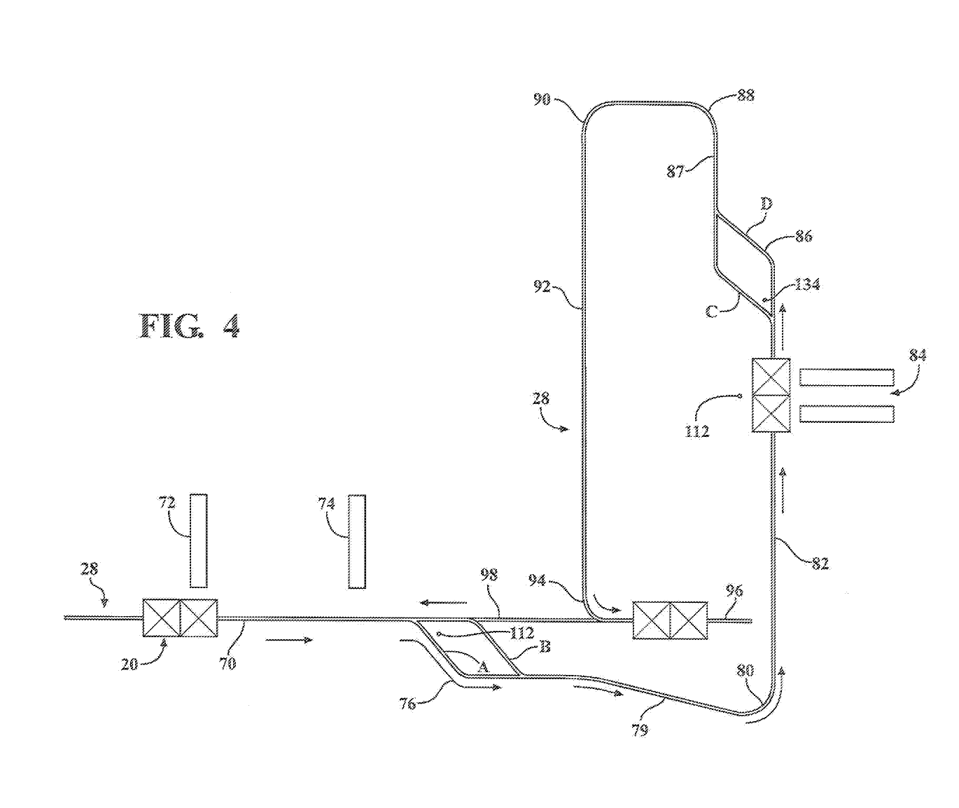

In the following discussion, the terms “forward direction of movement” and “rearward direction of movement” are taken with respect to the normal progression of the AGV 20 around the typically closed loop guide path 28 as shown in FIG. 4 and described hereafter. This terminology is used by example as the AGV 20 is constructed for bi-directional movement in either of a first direction or direction A and an opposite second direction, such as direction B.

A plurality of pivotal caster wheels 53 may be mounted adjacent opposite corners of the base 23 to provide stability for the AGV 20.

A controller 55, which may include a central processor unit and memory, executes a control program stored in the memory to react to signals from sensors carried on each chassis 21 and other indicators located along a surface, such as a plant floor, road surface at the like, as well as the magnetic signals from the guide surface, such as the guidepath or track 28 which is typically in the form of a magnetic tape, to move the AGV 20 along the guidepath 28 in a prescribed direction of movement between one or more stop locations to load and unload parts, etc.

The guidepath 28 may also be formed of an optically reflective tape which can be detected by an optical sensor carried on the AGV 20.

Consistent with the forward and rearward bi-directional movement of each of the first and second drive wheels 22 and 24, a pair of sensors 60 and 62 for the first drive wheel 22, and a pair of sensors 64 and 66 for the second drive wheel 24 are carried by each chassis 21. The sensors, 60, 62, 64 and 66, which may be Hall effect sensors, detect the magnetic field of the magnetic tape forming the guidepath 28 to provide signals to the controller 55 so that the controller 55 can direct the steering mechanisms 56 and 58 to retain the first and second drive wheels 22 and 24 on the guidepath 28 as the first and second drive motors 50 and 52 propel the AGV 20 along the guidepath 28 in the prescribed path.

Turning now to FIG. 4, there is depicted an example of a generally closed loop guidepath.

By way of example, the guidepath 28 includes a first linear portion 70 in which the AGV 20 moves between at least one or a pair of part or article load stations 72 and 74. The parts are moved by automatic equipment carried at the article load stations 72 and 74 and/or on the base 23 of the AGV 20 to load the parts from the load stations 72 and 74 onto article support structure carried on the base 23.

After leaving the load station 74, the AGV 20 executes a right side step motion or crab turn at location 76 on the guidepath 28. The method and apparatus used to implement the side step turn will be described in greater detail hereafter.

After completing the right side step motion, the AGV 20 then traverses along a slight curved segment 79 before making a less than 90° left turn at location 80.

The AGV 20 then traverses a second linear portion 82 of the guidepath 28 until it reaches unload station 84. The parts carried on the chassis 21 of the AGV 20 are then unloaded by automatic conveying equipment from the support structure on the chassis 21 of the AGV 20 to the structure of the unload station 84.

After leaving the unload station 84, the AGV 20 executes a left hand or left directed side step motion at guidepath location 86 before executing two consecutive left turns at location 88 and 90 before entering a third linear portion 92 of the guidepath 28.

By way example, the AGV 20 then executes a left turn at location 94 into a short linear segment 96 of the guidepath 28. Upon coming to a stop, the AGV 20 reverses direction and then moves in a rearward direction along linear segment 98, past location 76 back to a stop position at load station 72.

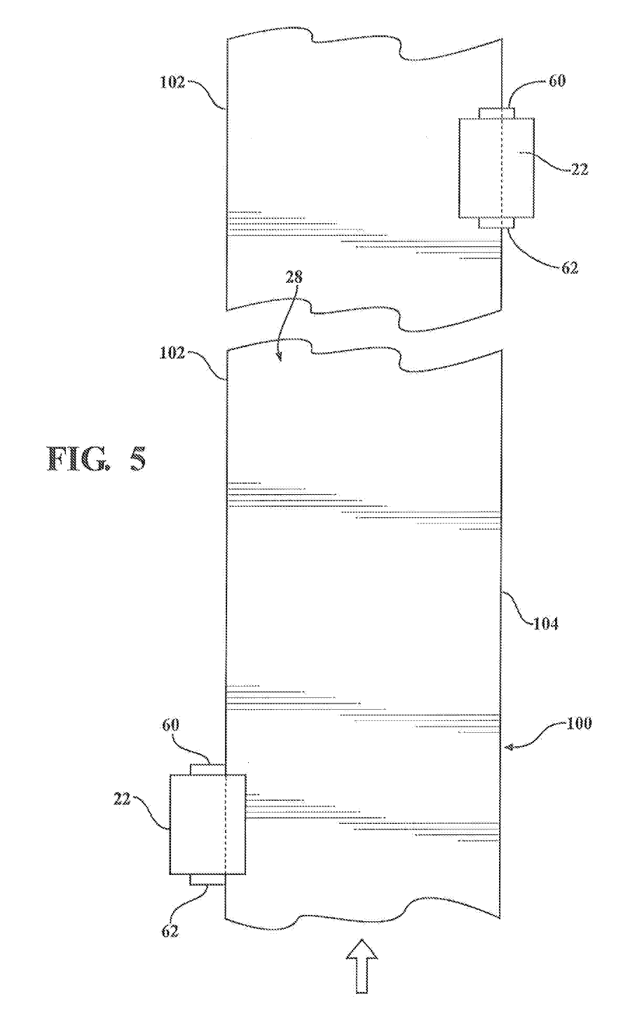

The details of the side step motion method and apparatus to implement the method will now be described in conjunction with FIGS. 5-12, for example.

As shown in FIG. 5, the guidepath 28 is formed of a magnetic tape 100. The guidepath tape 100 has a narrow width of generally 50 mm, for example, with a left edge 102 and a right edge 104, as viewed in the forward movement or direction of movement of the AGV 20 along the guidepath 28.

By convention only, AGV 20 is programmed to use the left edge 102 of the magnetic tape 100 as a default guide edge. The controller 55, in response to signals from the sensors 60 and 64 associated with the first and second drive wheels 22 and 24, moves the first and second drive wheels 22 and 24 to the left edge 102 of the magnetic tape 100. The sensors 60 and 64 detect the presence of the magnetic field from the magnetic tape 100 and the absence of a magnetic field adjacent to the left edge 102 to locate the left edge 102 of the magnetic tape 100.

As the AGV 20 approaches an upcoming left hand or left directed side step motion or a right hand or right directed side step motion location on the guidepath 28, the controller 55, with or without control signals from a programmable logic controller or PLC 54, also mounted on the chassis 21, determines when the AGV 20 has reached a position in advance of a right or left side step turn. In the case of a right side step turn, such as the right side step turn at location 76 shown in FIG. 4 on the guidepath 28, once the controller 55 has determined that the AGV 20 has reached a position to start the right side step turn, the controller 55 switches the position of the AGV 20 to the right edge 104 of the magnetic tape 100 for right edge sensing.

Oppositely, when the AGV 20 is approaching a left side step turn, the controller 55 before reaching the location of the start of the left side step turn, the controller 55 will switch the position of the AGV 20 relative to the magnetic tape 100 to the right edge 104 sensing of the magnetic tape 100.

In order to facilitate the first right hand or right directed side step movement of AGV 20 along the guidepath 28 at location 76 shown in FIG. 4, the AGV 20 includes a turn indicator sensor 110 carried on the base 23 of the AGV 20. The turn indicator sensor 110 is adapted for sensing a turn indicator 112, such as a RFID tag, fixed in the plant floor at a location to provide appropriate turn signals to the controller 55 of the AGV 20. The right directed side step turn uses a cross track segment A and a spaced, generally identical and generally parallel disposed cross track segment B, each formed of the same magnetic tape forming as the magnetic tape 100 in the main portion of the guidepath 28.

Each cross track segment B and A has a smoothly curved end segments which merge smoothly with the magnetic tape 100 of the guidepath 28 as well as the linear portions 78 of the guidepath 38. In between the curved end portions of each cross track A and B is a generally linear segment which is disposed in parallel with the corresponding segment of the other cross track B or A.

As the AGV 20 traverses along the first linear portion 70 of the guidepath 28, the sensor 110 carried on the chassis 21 of the AGV 20 detects the turn indicator 112 when the AGV 20 reaches the location of the turn indicator 112 as shown in FIG. 7.

When the turn indicator sensor 110 on the AGV 20 is located in proximity with or directly over a turn indicator 112 on the plant floor, the first drive wheel 22 will be positioned past the beginning curved segment of the cross track A. Since the controller 55 of the AGV 20 has previously positioned the AGV 20 so that the drive wheels 22 and 24 are moving along the left edge 102 of the magnetic tape 100 as shown in FIG. 5, the first drive wheel 22 continues past the curved entry portion of the cross track A and does not follow the cross track A.

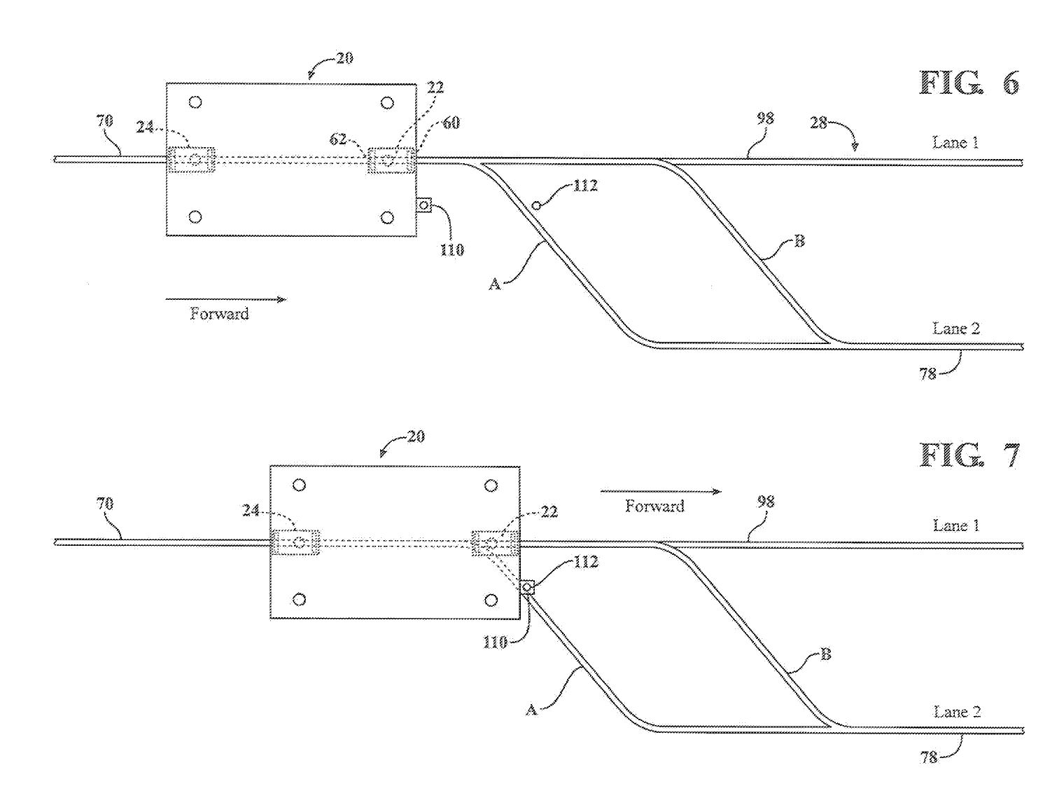

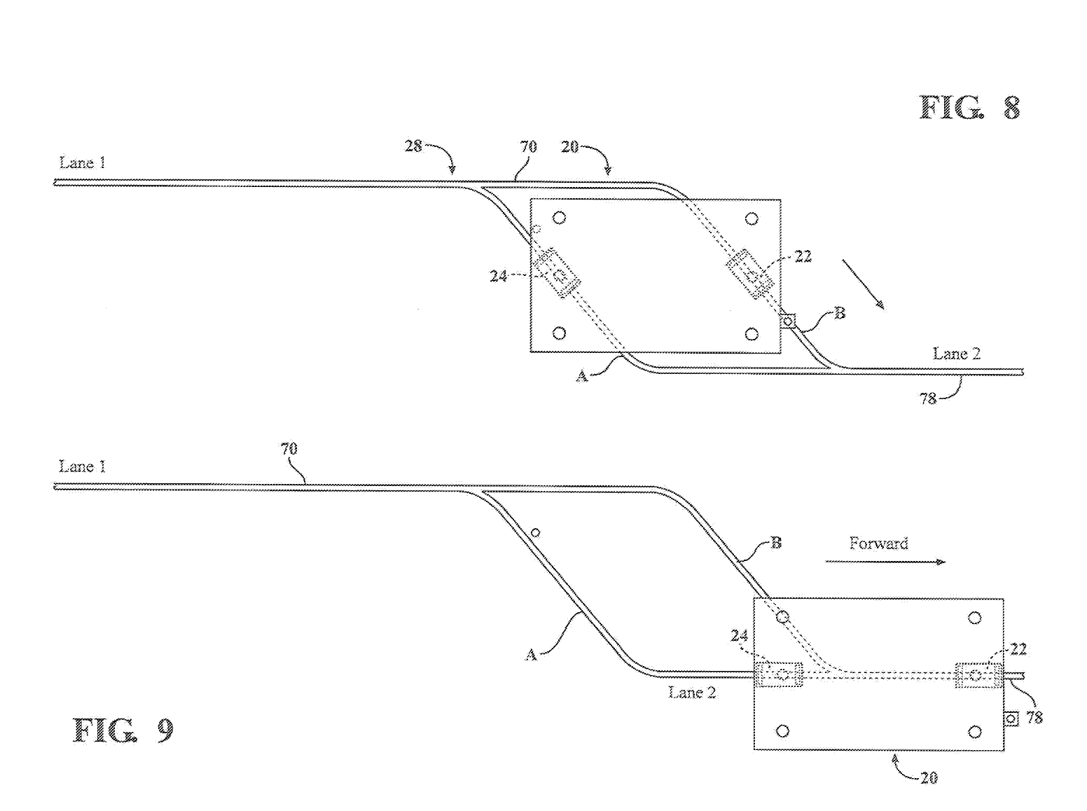

However, after the AGV 20 senses that it has reached the turn location position shown in FIG. 7, the controller 55, upon receiving a signal from the turn indicator sensor 110 that it has sensed the turn indicator 112, sends signals to the first and second drive wheels 22 and 24 steering mechanisms to direct the first and second drive wheels 22 and 24 to the right edge 104 of the magnetic tape 100. In this position, the drive wheels 22 and 24 are positioned to follow the curved entry portions of the cross tracks B and A, respectively, and move along the cross tracks B and A as shown in FIG. 8. This moves the chassis 21 of the AGV 20 in a generally sideways, parallel, movement between the spaced linear portions 78 and 80 of the guidepath 28, also depicted in FIGS. 6-9 as lane 1 and lane 2, respectively.

The AGV 20 continues along the first and second cross tracks A and B and follows the right edge of the magnetic tape 100 forming each of the cross tracks A and B as it moves through the curved end portions of the cross tracks A and B into the generally linear portion 78 or lane 2 of the guidepath 28.

After the drive wheels 22 and 24 of the AGV 20 have reentered the linear portion 78 of lane 2 of the guidepath 38, either based on a measured distance traveled along the linear portions 78 or, alternately, based on time of travel along the linear portion 78, the controller 55 switches back to left edge 102 sensing of the magnetic tape 100.

Referring back to FIG. 4, after executing the right side step motion at location 76 in the guidepath 28, the AGV 20 traverses through the curved segment 79, the left turn segment 80, and the second linear segment 82 until it reaches the unload station 84.

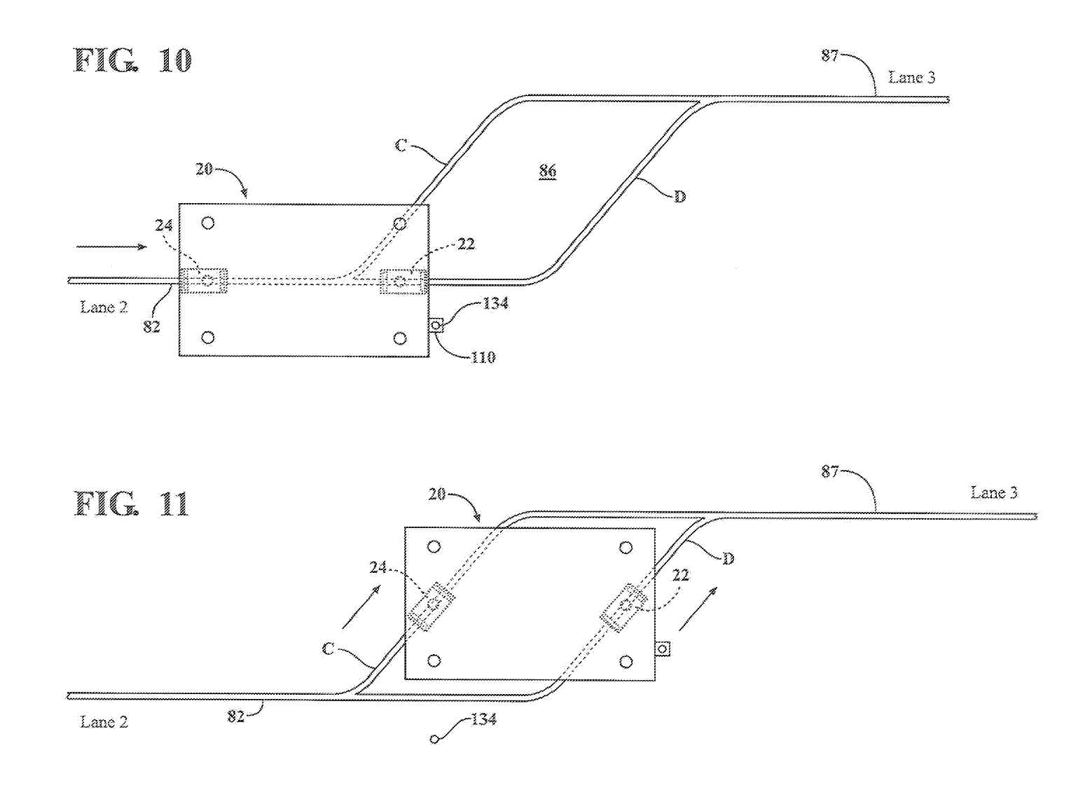

At the completion of the unloading operation, a drive signal generated by the PLC 54 to the controller 55 will cause the AGV 20 to move in a forward direction on the guidepath 28 shown in FIG. 10. The controller 55, based on a distance measurement from the unload station 84 or, time of travel measurement after leaving the unload station 84, or the actual position of the AGV 20 reaching a predetermined point after leaving the unload station 84, switches the position of the drive wheels 22 and 24 to follow the right edge 104 of the magnetic tape 100 so that the drive wheels 22 and 24 follow the first and second cross tracks D and C of the left hand side step turn 86. As the AGV 20 moves in a generally parallel side step or crab motion between the linear portion 82 of the guidepath, as shown in FIG. 11 to the short linear segment ahead of the left turn segment 88 of the guidepath 28, the drive wheels 22 and 24 traverse along the first and second tracks D and C and smoothly merge and then follow the linear portion of lane 3 of the guidepath 28 ahead of the left turn segment 88.

As shown in FIG. 10, since the turn indicator sensor on the AGV 20 is mounted in a fixed location on the AGV 20, the turn indicator 134, which is mounted at a suitable location relative to the cross tracks C and D to indicate to the PLC 54 that a left side step or sideways turn is necessary, is mounted in a predetermined position relative to the cross tracks C and D, but is located outside of the lane 2 of the guidepath 28, rather than between lane 2 and a parallel lane, referred to here as lane 3, or between the cross tracks C and D as in the previous side step turn location shown in FIGS. 6-9.

The remainder of the movement of the AGV 20 along the guidepath 28 shown in FIG. 4 follows left and right turns and forward and reverse directions of movement until the AGV 20 returns to the load station 72 shown in FIG. 4.

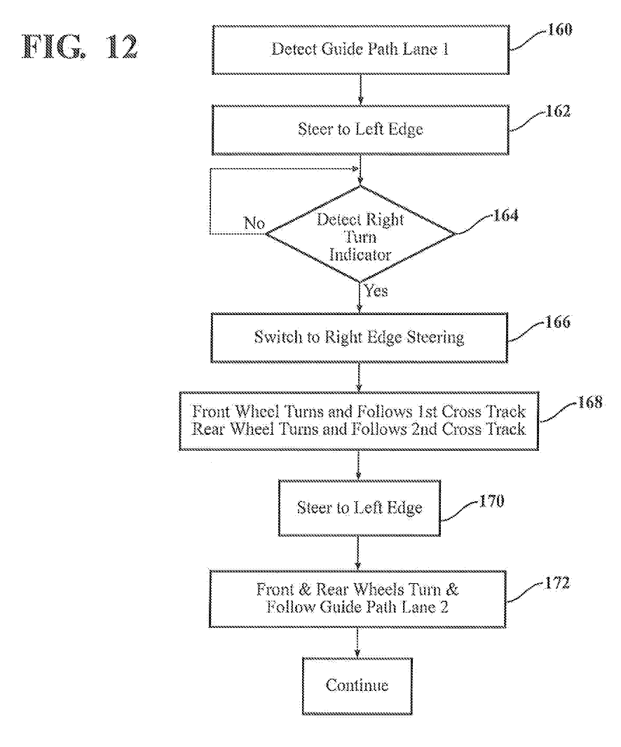

The control sequence implemented by the PLC 54 in directing the AGV 20 in a right hand sidestep or sideways crab turn is shown in FIG. 12.

In a forward movement direction 64, the AGV 20 traverses along the guidepath 28 with the sensors 60 and 64 associated respectively with the first drive wheel 22 and the second drive wheel 24 detecting the magnetic tape 100 in step 160. The output of the sensors 60 and 64 are input to the PLC 54 which then outputs to controller 55 direct to the front and rear steering mechanisms 56 and 58 to rotate in a direction to rotate the first drive assembly and the second drive assembly in the appropriate direction to position the AGV 20 toward the left edge 102 of the guidepath 28 as shown in FIG. 5 and depicted in step 160 in FIG. 12.

When the AGV 20 reaches the position 76 of the first sideways or crab turn as shown in FIG. 4, the sensor 110 will detect the turn indicator 112 mounted on or imbedded in the facility floor. At this time, the AGV 20 is in the position shown in FIG. 7 in which the first drive wheel 22, viewed in the direction of forward motion of the AGV 20 along the guidepath 28, is positioned beyond the cross track A and B.

Upon detecting the turn indicator 112 in step 164, the PLC 54 activates the front and rear steering mechanisms 56 and 58 to move the AGV 20 to the right edge sensing position along the right edge 104 of the guide strip 28 as shown in FIG. 5 in step 166 in FIG. 12.

As the first guidepath 28 smoothly merges into the cross tracks A and B in step 168, the front sensors 60 and 64 associated with the first and second drive wheels 22 and 24, respectively, will follow the right edge from the linear portion 70 of the guidepath 28 to the smoothly continuous right edges of the cross tracks A and B.

In step 170, front sensors 60 and 64 detect the right turn and send signals to the PLC 54 which activates the steering mechanisms 56 and 58 to turn the first and second drive wheels 20 and 22 in a direction to allow the first and second drive wheels 20 and 22 to respectively follow the cross tracks A and B.

Since a right sideways turn or movement ends in the second guidepath 78 which is, by example, substantially parallel to the first guidepath 28, the first and second cross tracks B and A smoothly merge with the second guidepath 78 in a left turning curve. Thus, as shown in step 170, after the AGV 20 enters the first and second cross tracks A and B as shown in FIG. 8, the PLC 54, either based on distance traveled, time or a signal from a position sensor, sends signals to the steering mechanisms 56 and 58 to again drive the AGV 20 to the left edge 102 of the cross tracks A and B. In this manner, the sensors 60 and 64 track the left edge 102 of the second guidepath 78 in step 172 to enable the AGV 20 to continue traversing the linear portion of the second guidepath 78.

A left crab or sideways turn by the AGV 20 is executed in the same manner as the sequence of steps shown in FIG. 12, except that the turn is to the left relative to the forward direction of movement of the AGV 20.

The same sequence is also followed when the AGV 20 is moving in a rearward direction with the sensors 66 and 62 acting as the front most sensors for the AGV 20. In reverse direction of movement, a right turn corresponds to a left turn in the forward direction or movement. A left turn in a rearward direction corresponds to a right turn in the forward direction or movement.

Although a separate turn indicator sensor can be mounted on the AGV 20 and used or activated solely when the AGV 20 is moving in a reverse direction or direction B along the guidepath 28, for economy, the same turn signal indicator 112 used for the forward direction of movement of the AGV 20, as described above, is employed to detect turn indicators mounted in the plant floor to communicate a left or right hand side step turn when the AGV 20 is moving in a rearward direction. In this situation, the turn indicator 112 is mounted on the plant floor at a position ahead of first left or right cross track, so as to be detected by the turn indicator sensor 110 on the AGV 20, now located along the rear edge of the AGV 20, while at the same time, the now forward most drive wheel, such as drive wheel 24 in the rearward direction or movement of the AGV 20, has passed the first cross track and is located between the first and second cross tracks as described above.

It should be noted that the cross tracks A and B, and C and D, are disposed at an approximate 45° included or acute angle relative to the linear portion of the first guidepath 28. It will be understood that other angular orientations of the first and second cross tracks A and B relative to the linear portion of the first guide track 28 may also be implemented, with a shallower or less than 45° angle being employed to move the AGV a smaller distance sideways or a steeper angle greater than 45° up to approximately 55°, for moving the AGV 20 a greater lateral distance between the first and second guidepaths 28 and 38.

It is also possible to move the AGV 20 in a U-turn between the first and second guidepaths 28 and 38 so that the AGV 20 traverses the second guidepath 38 in a rearward direction of movement as opposed to a forward direction of movement along the first guidepath 28. In executing a U-turn, part way through the U-portion of the two cross tracks, the second drive wheel 22 assumes a forward leading position relative to the original first drive wheel 20 and acts as a forward or front most drive wheel as the AGV 20 traverses in a reverse direction along the second guidepath 38.

What is claimed is:

1. An apparatus for controlling movement of an automated guided vehicle comprising;
a guidepath including a first guidepath portion and a second guidepath portion laterally offset from the first guidepath portion;
a first cross track interconnected between the first and second guidepaths portions;
a second cross track spaced from the first cross track and interconnected between the first and second guidepath portions;
an automated guided vehicle movable in at least a first direction of travel along the guidepath, the automated guided vehicle including:
a first independently steerable drive wheel;
a second independently steerable drive wheel;
a first sensor carried on the automated guided vehicle and associated with the first drive wheel for sensing the guidepath relative to the first drive wheel;
a second sensor carried on the automatic guided vehicle and associated with the second drive wheel for sensing the guidepath relative to the second drive wheel; and
a controller, in response to a position of the automatic guided vehicle relative to the first and second guidepath portions, controlling the position of the automatic guided vehicle to allow the first drive wheel to follow one of the first and second cross tracks and the second drive wheel to follow the other of the first and second cross tracks to move the automatic guided vehicle laterally between the first and second guidepath portions.

2. The apparatus of claim 1 further comprising:
a turn indicator fixedly positioned relative to the first and second cross tracks;
a turn indicator sensor carried by the automatic guided vehicle for detecting the turn indicator; and
the controller, using an output from the turn indicator sensor, to determine a position of the automatic guided vehicle relative to the first and second cross tracks to control the movement of the automatic guided vehicle along the first and second cross tracks.

3. The apparatus of claim 1 further comprising:
a third sensor mounted rearwardly of the first drive wheel to sense the guidepath when the automatic guided vehicle is moving in a second direction of travel opposite from the first direction;
a fourth sensor mounted rearwardly of the first drive to sense the guidepath when the automatic guided vehicle is moving in a second direction of travel opposite from the first direction.

4. The apparatus of claim 3 further comprising:
a bi-directional drive motor coupled to each of the first and second drive wheels.

5. The apparatus of claim 1 wherein:
the second guidepath portion is disposed to a right side of the first guidepath portion with respect to the first direction of travel of the automatic guided vehicle along the guidepath.

6. The apparatus of claim 1 wherein:
the second guidepath is disposed to a left side of the first guidepath portion with respect to the first direction of travel of the automatic guided vehicle.

7. The apparatus of claim 1 further comprising:
the first and second cross tracks disposed at an angle between the first and second guidepath portions.

8. The apparatus of claim 7 wherein:
an included angle of each of the first and second cross tracks relative to the first and second guidepath portions is approximately 45°.

9. The apparatus of claim 2 further comprising:
the turn indicator fixedly mounted relative to the first and second cross tracks in a position such that the turn indicator sensor detects the presence of the turn indicator only when the first drive wheel of the automatic guided vehicle is positioned between the first and second cross-tracks when the automatic guided vehicle is moving in the first direction of travel.

10. The apparatus of claim 1 wherein:
the first and second drive wheels are longitudinally spaced apart.

11. A method of controlling movement of an automatic guided vehicle along a guidepath including at least a first guidepath portion the automatic guided vehicle including first and second independently steerable drive wheels, comprising:
providing a second guidepath laterally offset from the first guidepath;
interconnecting first and second spaced cross tracks between the first and second guidepaths;
mounting a turn indicator in a position relative to the first and second cross tracks to indicate a lateral sideways turn movement of the automatic guided vehicle from the first guidepath to the second guidepath;
providing a turn indicator sensor on the automatic guided vehicle for detecting the turn indicator; and
executing a stored program by a controller to control the movement of the automatic guided vehicle along the first guidepath, and, in response to a signal from the turn indicator sensor, controlling the position of the automatic guided vehicle to allow the first drive wheel to follow one of the first and second cross tracks and the second drive wheel to follow the other of the first and second cross tracks to move the automatic guided vehicle laterally between the first and second guidepaths.

12. The method of claim 11 further comprising:
mounting the turn indicator between the first and second cross tracks in a position so that the first drive wheel passes the first cross track before the turn indicator sensor detects the turn indicator.

13. The method of claim 11 further comprising:
disposing the second guidepath portion laterally to a right side of the first guidepath with respect to the first direction of travel of the automatic guided vehicle along the first guidepath.

14. The method of claim 11 further comprising:
disposing the second guidepath laterally to a left side of the first guidepath with respect to the first direction of travel of the automatic guided vehicle along the first guidepath.

15. The method of claim 11 further comprising:
disposing the first and second cross tracks at non-perpendicular angles with respect to the first and second guidepaths.

16. The method of claim 15 further comprising:
forming an angle of the first and second cross tracks with respect to the first and second guidepath portion at an approximately 45° angle.
